(19) United States
(12) Patent Application Publication
(10) Pub. No.: US 2014/0072146 A1
(43) Pub. Date: Mar. 13, 2014

(54) OPTICAL MICROPHONE AND METHOD FOR DETECTING BODY CONDUCTED SOUND SIGNALS

(71) Applicants: Yuval Itkin, Zoran (IL); Raifel Mark, Ra'anana (IL); Moshe Haiut, Ramat Gan (IL)

(72) Inventors: Yuval Itkin, Zoran (IL); Raifel Mark, Ra'anana (IL); Moshe Haiut, Ramat Gan (IL)

(73) Assignee: DSP Group, Herzelia (IL)

(21) Appl. No.: 13/612,916

(22) Filed: Sep. 13, 2012

(51) Int. Cl. H04R 3/00

(52) U.S. Cl. CPC H04R 3/00
USPC 381/111

(57) ABSTRACT

A method and an optical microphone that may include a transmitter; and a sensor; wherein the transmitter is arranged, when facing an external auditory canal of a user, to direct optical signals towards an area of the external auditory canal; wherein the sensor is arranged to generate sensing signals that are indicative of reflected radiation that reflected from the external auditory canal; wherein the reflected radiation conveys information about body conducted signals that propagate through a body of the user and cause the external auditory canal to vibrate.

### BACKGROUND OF THE INVENTION

An optical microphone includes an internal element (such as an internal membrane) that is expected to vibrate in response to sound signals. Vibrations of the internal element are sensed by an optical transceiver of the optical microphone.

US patent application 2008/0107292 of Kornagel discloses a behind-the-ear hearing device having an external optical microphone. The optical microphone includes an internal membrane that is optically scanned by the optical microphone.

A bone conduction sensor contacts a tissue of a user in order to detect body conducted signals that propagate through one or more bones of a user.

US patent application 2002/0118852 of Boesen discloses a voice communication device that includes a bone conduction sensor and an air conduction sensor. The bone conduction sensor contacts a portion of the external auditory canal in order to detect body conducted signals.

Headsets that include an earphone, an external microphone, and a bone conduction microphone may be too cumbersome compared to headsets that do not include bone conduction microphone.

There is a growing need to provide an efficient device for detecting bond conducted sounds.

### SUMMARY OF THE INVENTION

According to an embodiment of the invention an optical microphone may be provided and may include a transmitter and a sensor. The transmitter may be arranged, when facing the external auditory canal of a user, to direct optical signals towards an area of the external auditory canal. The sensor may be arranged to generate sensing signals that may be indicative of reflected radiation that reflected from the external auditory canal. The reflected radiation conveys information about body conducted signals that propagate through a body of the user and cause at least one of the eardrum and the external auditory canal to vibrate.

The sensor may be coupled to a processor that may be arranged to process the sensing signals to provide output signals indicative of the body conducted sound signals.

The optical microphone may include a processor that may be arranged to process the sensing signals to provide output signals indicative of body conducted sound signals that propagate through the user and cause the external auditory canal to vibrate.

The optical microphone may include an interference generator that may be arranged to generate interference patterns between (a) a portion of the optical signals, and (b) the reflected radiation; and the sensor may be arranged to generate the sensing signals in response to the radiation patterns.

The interference generator may be a prism.

The interference generator may be a set of prisms that may include at least two spaced apart prisms.

The optical microphone may include a set of sensors, each sensor may be arranged to detect interference patterns generated by a single prism of the set of prisms.

The processor may include an amplitude analyzer that may be arranged to perform an amplitude based analysis of the detection signals to extract information about the body conducted sound signals.

The processor may include a phase analyzer that may be arranged to perform a phase based analysis of the detection signals to extract information about the body conducted sound signals.

The processor may include a polarization analyzer that may be arranged to perform a polarization based analysis of the detection signals to extract information about the body conducted sound signals.

The processor may include an amplitude analyzer that may be arranged to perform an amplitude based analysis of the detection signals to extract information about the body conducted sound signals.

The processor may include a phase analyzer that may be arranged to perform a phase based analysis of the detection signals to extract information about the body conducted sound signals.

The processor may include a polarization analyzer that may be arranged to perform a polarization based analysis of the detection signals to extract information about the body conducted sound signals.

At a certain point in time the optical signals may form a beam of radiation.

The optical signals may form multiple beams of radiation.

The multiple beams of radiation may include at least two beams of radiation that differ from each other by frequency.

The multiple beams of radiation may include a visible light beam of radiation and an infra red beam.

The multiple beams of radiation may include at least two beams of radiation that propagate along optical paths that may be oriented in relation to each other.

The multiple beams of radiation may include at least two beams of radiation that differ from each other by frequency and direction of propagation.

The sensor may be arranged to generate sensing signals that may be indicative of reflected radiation that may be reflected from the area of the external auditory canal.

The sensor may be arranged to generate sensing signals that may be indicative of reflected radiation that may be reflected multiple times from multiple areas the external auditory canal.

The optical signals may be infrared optical signals.

The optical signals may be visible light optical signals.

The processor may include a user motion reduction module that may be arranged to suppress information attributed to physical movements of the user.

The transmitter may be arranged to direct optical signals towards the area during time windows that may be spaced apart in time.

The width of each time window may be a fraction of a period between adjacent time windows.

The optical microphone may include a housing that at least partially surrounds the transmitter, the sensor and the processor. The housing may be adapted for insertion into the external auditory canal of the user—it may have a part that has a shape that fits a space (or a portion of that space) formed by the external auditory canal.

The housing, when inserted into the external auditory canal of the user may block the external auditory canal of the user.

The housing, when inserted into the external auditory canal of the user may not block the external auditory canal of the user.

The optical microphone may include multiple sensors.

The multiple sensors may include at least two sensors that sense different wavelengths.

The multiple sensors may include at least two sensors that may be arranged to sense radiation from different areas of an ear of the user.

There may be provide method for detecting body conducted signals, the method may include transmitting, by a transmitter that faces the external auditory canal of a user, optical signals towards an area of the external auditory canal; and generating, by a sensor, sensing signals that may be indicative of reflected radiation that may be reflected from the external auditory canal. The reflected radiation conveys information about body conducted signals that propagate through a body of the user and cause the external auditory canal to vibrate.

The method may include processing the sensing signals to provide output signals indicative of the body conducted sound signals that propagate through the body of the user and cause the external auditory canal to vibrate.

The method may include generating interference patterns between (a) a portion of the optical signals, and (b) the reflected radiation; the generating of the sensing signals may be responsive to the radiation patterns.

The method may include generating the sensing signals by a set of sensors, each sensor detects interference patterns generated by a single prism of the set of prisms.

The method may include performing an amplitude based analysis of the detection signals to extract information about the body conducted sound signals.

The method may include performing a phase based analysis of the detection signals to extract information about the body conducted sound signals.

The method may include performing a polarization based analysis of the detection signals to extract information about the body conducted sound signals.

The method the transmitting may include transmitting at a certain point in time optical signals that form a beam of radiation.

The method may include transmitting multiple beams of radiation.

The multiple beams of radiation may include at least two beams of radiation that differ from each other by frequency.

The multiple beams of radiation may include a visible light beam of radiation and an infra red beam.

The multiple beams of radiation may include at least two beams of radiation that may propagate along optical paths that may be oriented in relation to each other.

The multiple beams of radiation may include at least two beams of radiation that differ from each other by frequency and direction of propagation.

The method may include generating sensing signals that may be indicative of reflected radiation that may be reflected from the area of the external auditory canal.

The method may include generating sensing signals that may be indicative of reflected radiation that may be reflected multiple times from multiple areas of the external auditory canal.

The method may include suppressing information attributed to physical movements of the user.

The method may include directing optical signals towards the area during time windows that may be spaced apart in time.

The width of each time window may be a fraction of a period between adjacent time windows.

The method may include generating the sensing signals by multiple sensors.

The method may include generating the sensing signals by least two sensors that sense different wavelengths.

The method may include generating the sensing signals by at least two sensors that may be arranged to sense radiation from different areas of an ear of the user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof may best be understood by reference to the following detailed description when read with the accompanying drawings in which:

FIG. 1 is a cross sectional view of a part of an ear of a user and of an optical microphone according to an embodiment of the invention;

FIGS. 2-8 illustrate optical microphones according to various embodiments of the invention;

FIGS. 9-10 illustrate portions of optical microphones according to various embodiments of the invention;

FIG. 11 illustrates a method according to an embodiment of the invention; and

FIG. 12 includes timing diagrams that represent two transmission modes according to various embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

Because the illustrated embodiments of the present invention may for the most part, be implemented using electronic and/or optical components and circuits known to those skilled in the art, details will not be explained in any greater extent than that considered necessary as illustrated above, for the understanding and appreciation of the underlying concepts of the present invention and in order not to obfuscate or distract from the teachings of the present invention.

There is provided an optical microphone that can detect light reflected from one or more areas of an ear of a user. The detected light is reflected from the external auditory canal.

The optical microphone may be arranged to direct optical signals that form one or more beams of radiation. At each point of time the optical microphone can transmit zero, one or multiple beams of radiation.

The optical microphone may be arranged to generate multiple beams of radiation.

The multiple beams may include at least two beams of radiation that differ from each other by frequency.

The multiple beams may include at least two beams of radiation that differ from each other by the optical paths they are expected to pass. The optical paths may differ from each other by orientation, length and, additionally or alternatively, number of reflections.

The multiple beams may include at least two beams of radiation that differ from each other by polarity.

The optical microphone may be arranged to generate multiple beams of radiation, wherein beams of radiation that are generated at different points in time may differ from each other by amplitude. Changes in the amplitude of these different beams may assist in expanding the dynamic range of the optical microphone, manage saturation or enhance signal to noise ratio.

The multiple beams may include at least two beams of radiation that differ from each other by modulation.

The multiple beams may include one or more visible light beams.

The multiple beams may include one or more infra red beams.

There is provided an optical microphone that can direct optical signals towards the external auditory canal. The optical signals can form a light beam, multiple light beams or have a radiation pattern that differs from or more light beams. The optical signals can irradiate the ear of the user in a continuous manner or in a non-continuous (cyclic) manner. Using non-continuous illumination can be more power efficient.

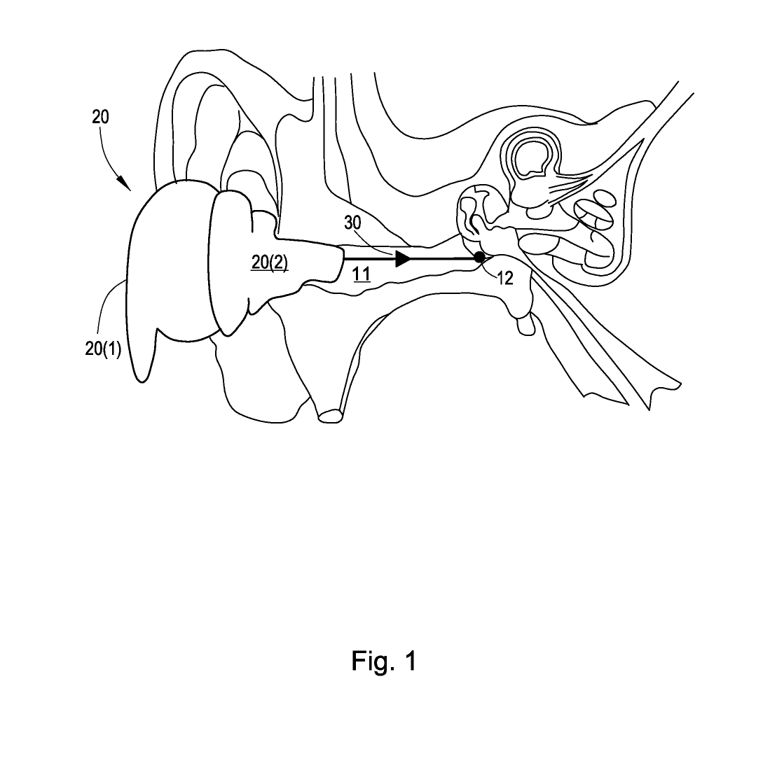

FIG. 1 is a cross sectional view of an ear 10 of a user and of an optical microphone 20 according to an embodiment of the invention.

The optical microphone 20 is illustrated as including two parts—first part 20(1) and second part 20(2). Both parts can be integrated to each other, proximate to each other or spaced apart from each other.

Second part 20(2) may be inserted (fully or partially) within the external auditory canal 11 of the user while the first part 20(1) may be located outside the external auditory canal 11.

FIG. 1 illustrates the optical microphone 20 as being inserted in the external auditory canal 11 of the user in a manner that blocks the external auditory canal 11. It is noted that non-blocking configurations of the optical microphone 20 can also be provided.

The optical microphone 20 of FIG. 1 is illustrates as directing a light beam 30 towards an area of the external auditory canal 11 that is very proximate to the eardrum 12 of the user. It is noted that other areas of the ear can be illuminated.

It is noted that the optical microphone 20 can direct the light beam 30 towards the external auditory canal 11.

The optical microphone 20 can be arranged to detect radiation that is reflected once or reflected multiple times from different areas of the ear of the user.

FIG. 1 illustrates a single reflection scheme in which light is expected to be detected by the optical microphone 20 after being reflected once from an area (so called illuminated area) of the external auditory canal 11.

This figure illustrates that the transmitted light beam 30 and the reflected radiation (not show) share a same optical path but this is not necessarily so. For example, the reflected radiation can propagate along an optical path that differs from the optical path of the transmitted light beam 30—by orientation, by location or both.

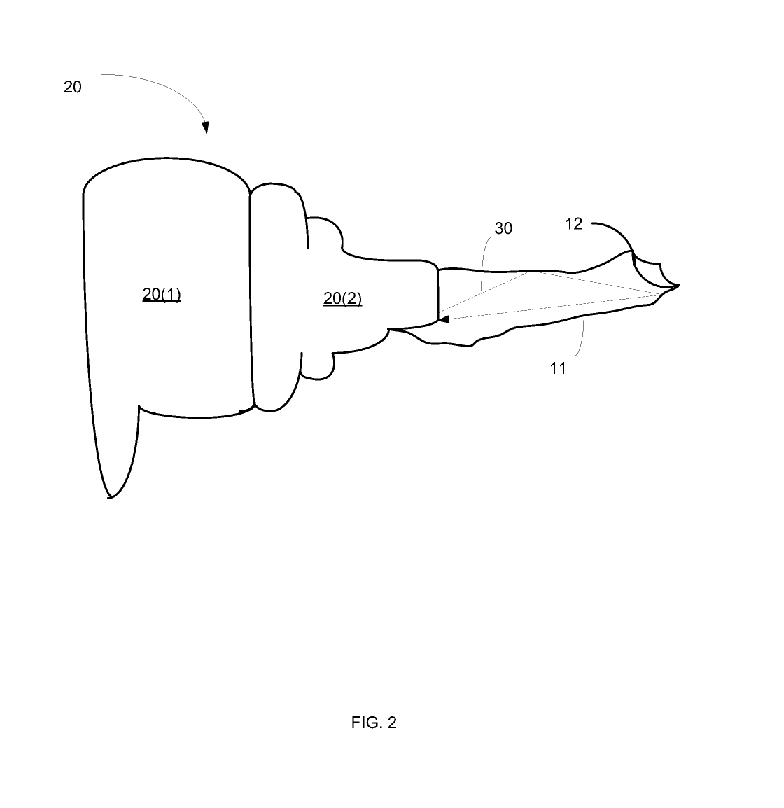

FIG. 2 illustrates an optical microphone 20 according to an embodiment of the invention. The optical microphone 20 is arranged to detect reflected radiation after the radiation is deflected three times. It is noted that the optical microphone 20 can be arranged to detect reflected radiation after the reflected radiation is reflected twice or is reflected more than three times.

FIG. 2 illustrates the light beam 30 as being directed towards an upper part of the external auditory canal 11 to be (a) deflected (once) towards the lower part of the external auditory canal 11, and (b) deflected (second) from the lower part of the external auditory canal 11 towards the optical microphone 20.

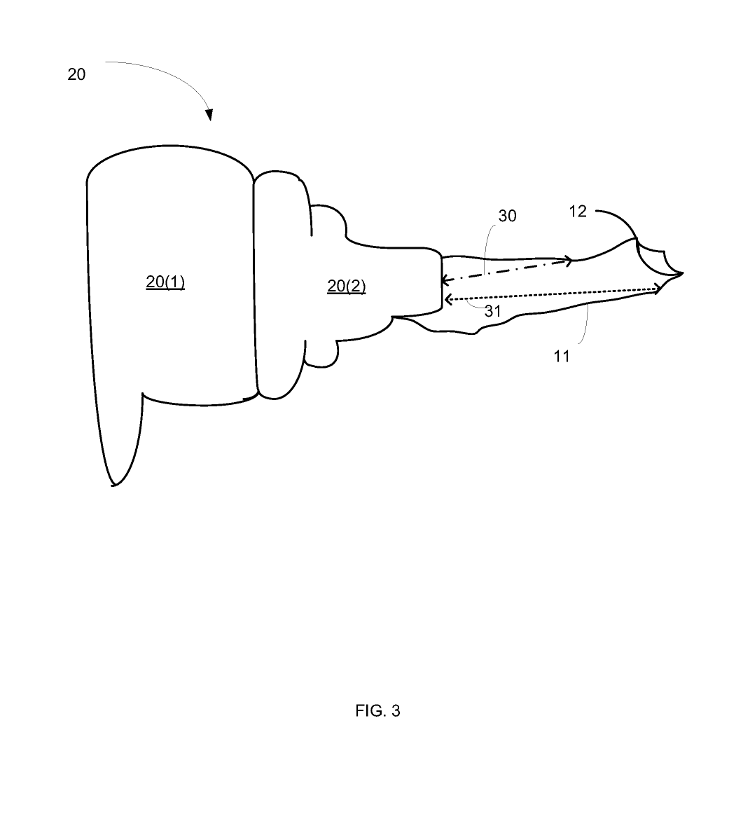

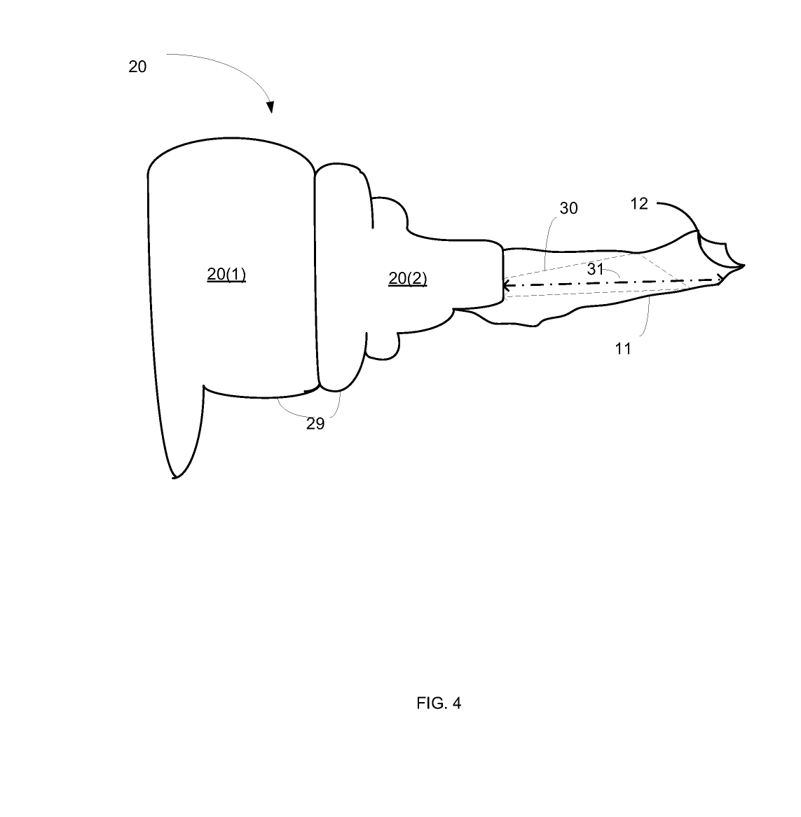

FIGS. 3 and 4 illustrate optical microphones 20 according to various embodiments of the invention.

In both FIGS. 3 and 4 the optical microphone 20 is arranged to transmit multiple light beams such as first and second light beams 30 and 31 that propagate along different optical paths. In FIG. 3 one light beam propagates towards the upper portion of the external auditory canal and the second light beam propagates towards the lower portion of the external auditory canal. In FIG. 4 one light beam is reflected once and the other is reflected multiple times.

The optical paths of the first and second light beams can differ by orientation, by location within the external auditory canal 11 (as illustrated in FIG. 3), by number of deflection (as illustrated in FIG. 4), or both.

The first and second light beams 30 and 31 can be of the same wavelength or of different wavelengths.

The first and second light beams 30 and 31 can have a same size, same polarization or same coherence level. The first and second light beams 30 and 31 may differ from each other by at least one optical characteristic.

Usage of light beams of different frequencies (such as light beams 30 and 31) can assist in solving phase ambiguity problems that may arise as a result from the relationship between the amplitude of the vibration of the external auditory canal 11 or the eardrum 12 and the wavelength of the first or second light beams.

The first and second light beams 30 and 31 can be transmitted simultaneously or can be transmitted at different points of time. The simultaneous or very proximate transmission of the first and second light beams can be beneficial for resolving phase ambiguities.

The proximity can be evaluated in comparison to the type of body conducted signals to be detected—for example—a proximity can be defined as a predetermined fraction (for example—less than 25%) of a period of a pronunciation of a single syllable. This proximity may facilitate the obtaining of information relating to the same syllable as a result of illuminating the ear of the user with multiple light beams of different wavelengths.

In other words—the time shift may be relatively small in comparison to the cycle (1/frequency) of the body conducted signals in order to obtain information about substantially the same body-conducted signals from the irradiation of the ear by two different light beams 30 and 31.

The time shift between a transmission of first light beam 30 and a transmission of a second light beams 30 and 31 can be large enough to allow an easy separation between detection signals generated in response to each of the first and second light beams. A large enough time period can be evaluated based upon the response period of the sensor of the optical microscope 20.

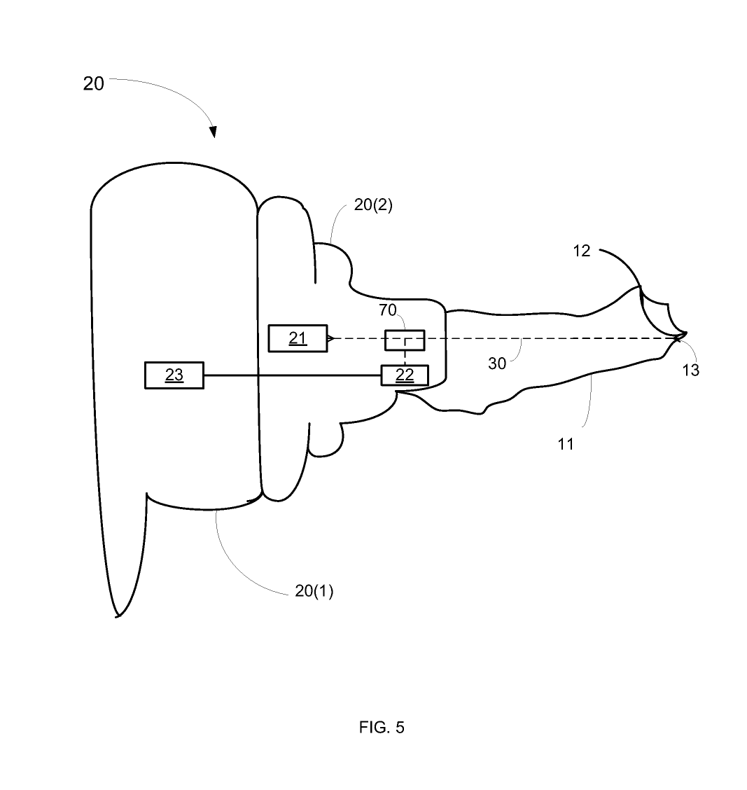

FIG. 5 illustrates an optical microphone 20 according to an embodiment of the invention.

The optical microphone 20 may include a transmitter 21 and a sensor 22. The optical microphone 20 can include a processor 23. Alternatively, the optical microphone 20 can be coupled to a processor 23.

FIG. 5 illustrates the processor 23 as being included in a first part 20(1) of the optical microphone 20 while the transmitter 21, optics 70 and sensor 22 as being included in the second part 20(2) of the optical microphone 20.

The external surface of the first and second parts 20(1) and 20(2) may form a housing 29 of the optical microphone 20.

The processor 23 may be proximate to the transmitter 21, may be proximate to the ear 10 of the user, may be located within a behind-the ear device, may be a part of a head set or may be located within any other device.

Although the mentioned above figures illustrates the processor 23 as being included in the optical microphone 20, the processor 23 can be coupled to the optical microphone 20 without being physically connected to the optical microphone 20.

The sensing signals from the sensor 22 can be wirelessly transmitted to the processor 23, can be conveyed by wire to the processor 23, can be stored in a memory module (not shown) before being provided to the processor 23 and the like.

The transmitter 21 may be arranged (when facing the external auditory canal 11 of a user) to direct optical signals towards an area of the external auditory canal. This area is referred to as an illuminated area 13.

The illuminated area 13 can be scanned over time by the transmitter or due to movements of the user. Alternatively—the optical signals can be directed to the same location.

The illuminated area 13 can be small in comparison to the entire area of the external auditory canal 11. For example, the illuminated area may be less than ten percents or even less than one percent of the external auditory canal 11.

The sensor 22 may be arranged to generate sensing signals that are indicative of reflected radiation that is reflected from the ear of the user as a result of the illumination of the illuminated area 13. As indicated above the sensor 22 can detect reflected radiation after the radiation has been deflected or reflected once or more times.

Additionally or alternatively, the sensor 22 may be arranged to generate sensing signals that are indicative of scattered radiation that is scattered from the ear of the user as a result of the illumination of the illuminated area 13.

Optics 70 can direct optical signals from the transmitter 21 towards the illuminated area 13, may scan the illuminated area or scan multiple illuminated areas, and may direct reflected radiation towards sensor 22.

Optics 70 can include illumination optics and collection optics. The illumination optics and the collection optics may share the same optical components but may differ from each other by at least one optical component. Non limiting examples of optical components are illustrated in some of the following figures.

The processor 23 may be arranged to receive the sensing signals and may be arranged to process the sensing signals to provide output signals. The output signals may be indicative of body conducted sound signals that propagate through the body of the user and cause the external auditory canal to vibrate.

These body conducted sound signals can be speech signals generated by the user himself.

The processor 23 may perform at least one type of analysis on the detections signals. These types of analysis may include an amplitude based analysis, a phase based analysis and a polarization based analysis.

Each analysis aims to estimate the body conducted sound signals that cause the external auditory canal to vibrate. These vibrations may change the length or another attribute of the optical path of the transmitted optical signals and/or the reflected radiation.

These changes in the optical paths can cause changes in the detection signals. The detection signals can be analyzed to detect the vibrations and estimate the body conducted signals.

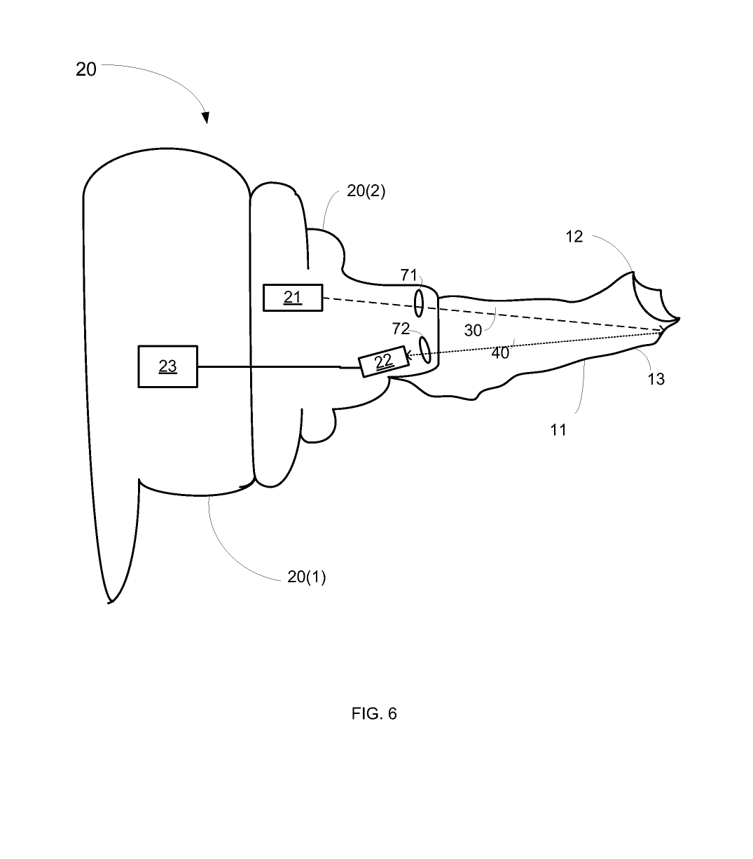

FIG. 6 illustrates optical microphone 20 according to an embodiment of the invention.

FIG. 6 illustrates the optical microphone 20 as having illumination optics 71 and collection optics 72 that differ from each other. FIG. 6 also illustrates reflected radiation 44 that propagates along an optical path that differs from the optical path of the beam of light 30.

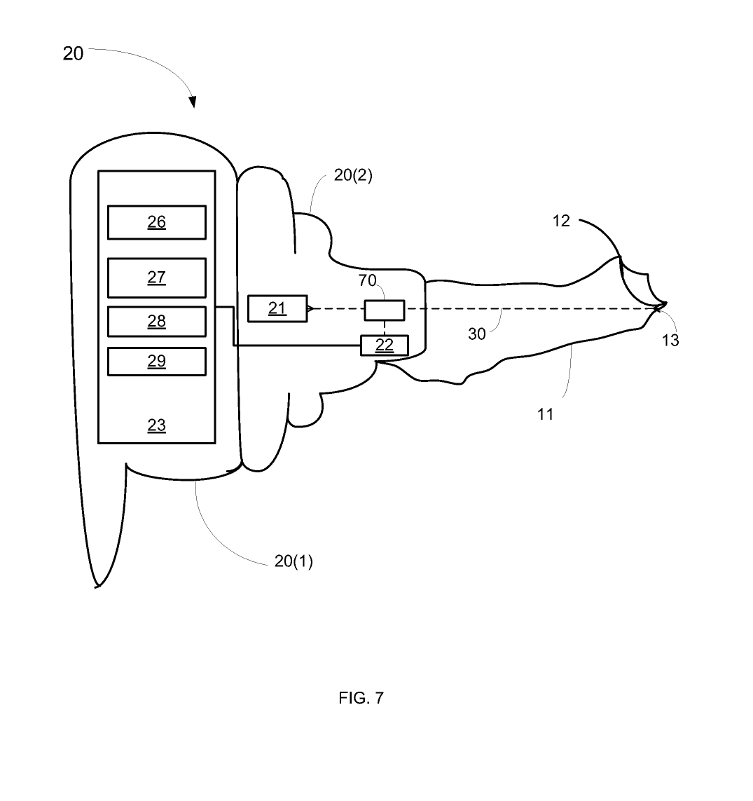

FIG. 7 illustrates optical microphone 20 according to an embodiment of the invention.

FIG. 7 illustrates a processor 23 that is capable of performing various types of analysis. It is noted that any processor 23 mentioned in the specification may perform one, two or more than three type of analysis.

These different types of analysis are illustrated by various modules of the processor 23:
1. An amplitude analyzer 27 that is arranged to perform an amplitude based analysis of the detection signals to extract information about the body conducted sound signals.
2. A phase analyzer 28 that is arranged to perform a phase based analysis of the detection signals to extract information about the body conducted sound signals.
3. A polarization analyzer 29 that is arranged to perform a polarization based analysis of the detection signals to extract information about the body conducted sound signals.

As indicated above—the processor 23 may include one or more of these analyzers.

Yet according to an embodiment of the invention the processor 23 may include a user motion reduction module 26 that is arranged to suppress information attributed to physical movements of the user.

Changes in the attributes of the reflected radiation due to movements of the user can be filtered out by using a high pass filter, as the frequency of such movements usually does not exceed 10 Hertz. The user motion reduction module 26 can (FFT) module or can be coupled to a time domain to frequency domain converter.

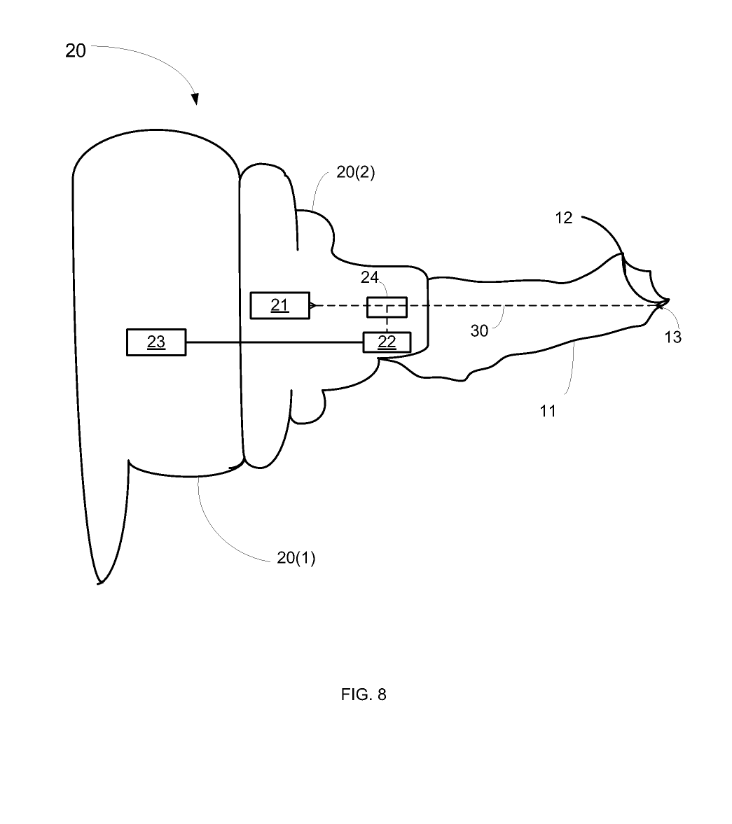

FIG. 8 illustrates an optical microphone 20 according to an embodiment of the invention.

The optical microphone 20 generates interference patterns between portions of the (transmitted) optical signals and reflected radiation.

Accordingly—the optics 70 of the optical microphone 20 may be an interference generator 24 or may include an interference generator 24. The interference generator 24 may be arranged to generate interference patterns between (a) a portion of the transmitted optical signals, and (b) the reflected radiation.

The sensor 22 detects the interference patterns—and it outputs sensing signals that are indicative of the radiation patterns.

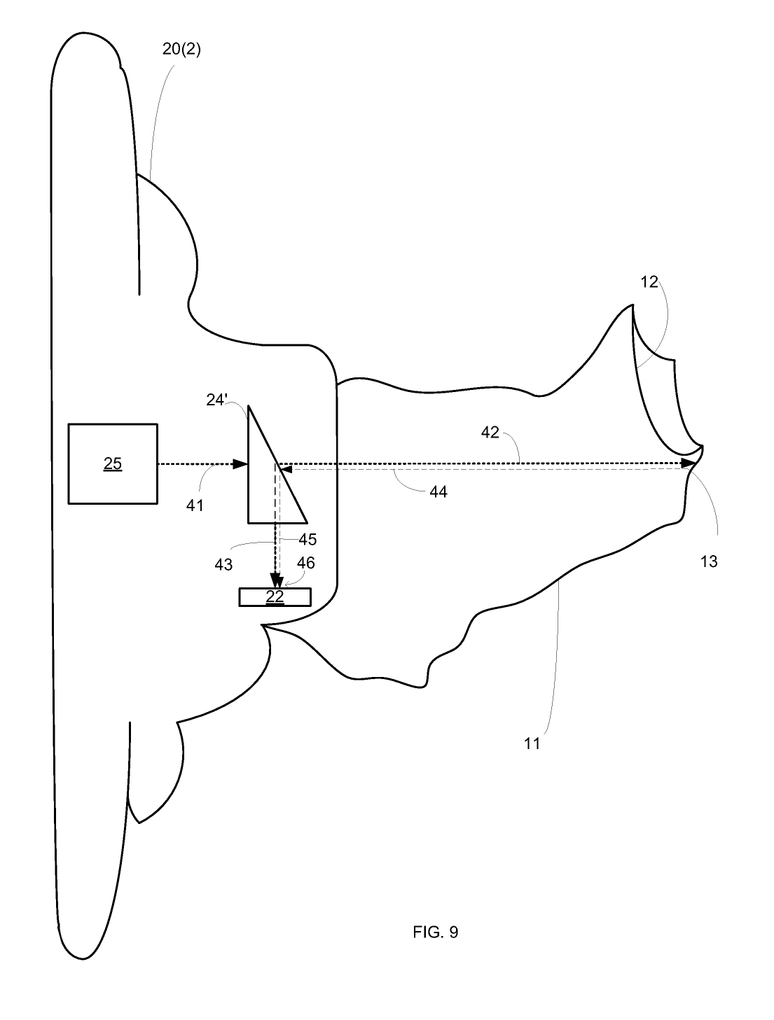

FIG. 9 illustrates an optical microphone 20 according to an embodiment of the invention.

In the optical microphone 20 of FIG. 9 the interference generator is a prism 24′.

FIG. 9 also illustrates the transmitter as including a light source such as a light emitting diode (LED) 25 that transmits first optical signals 41 such as coherent laser pulses or a coherent and continuous laser light beam.

The first optical signals 41 pass through the prism 24′.

Most of the first optical signals 41 (referred to as transmitted optical signals 42) are directed by the prism 24′ towards the illuminated area 13 while a small portion of the first optical signals (referred to as second optical signals 43) are directed towards the sensor 22.

The prism 24′ performs an energy based splitting and the transmitted optical signals 42 have most of the energy of the first optical signals 41. It is noted that other types of splitting can be applied—for example polarity based splitting.

The prism 24′ also receives reflected radiation 44 that is reflected from the illuminated area 13 and may propagate along the same path (but in an inverted direction) as the transmitted optical signals 42.

The prism 24′ directs a portion 45 of the reflected radiation 44 towards the sensor 22 but along the optical path of the second optical signals 43 so that the portion 45 of the reflected radiation 45 and the second optical signals 43 form interference patterns 46 that are detected by the sensor 22.

The interference patterns 46 may be expected to be very sensitive to phase differences between the transmitted optical signals 42 and the reflected radiation 44.

It is noted that the vibrations of the illuminated area 13 are expected not to exceed in magnitude a half of a wavelength of the transmitted optical signals 42.

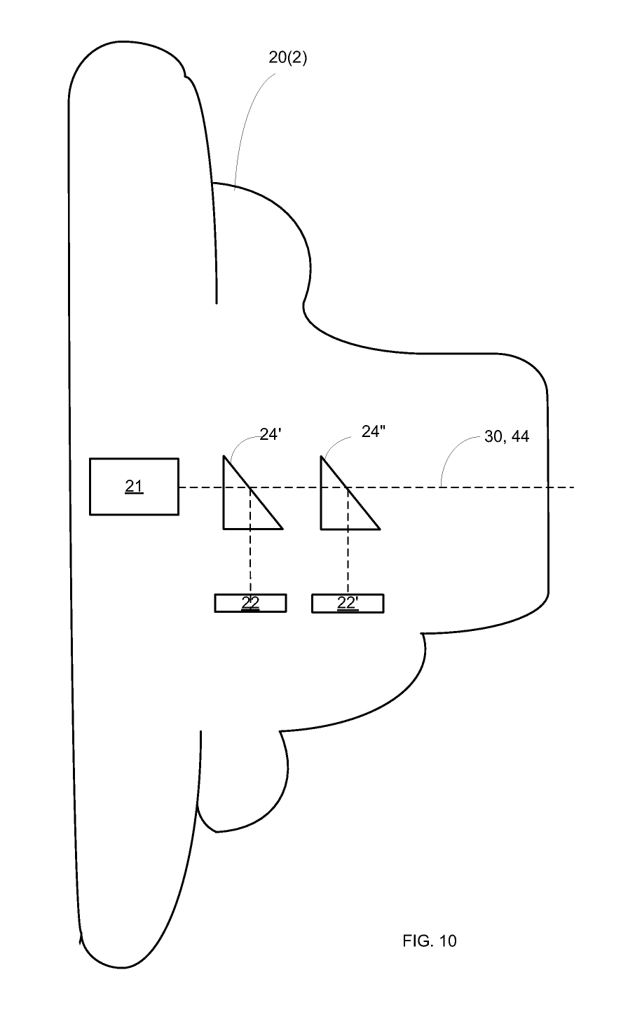

FIG. 10 illustrates an optical microphone 20 according to an embodiment of the invention.

The optical microphone 20 includes a set of prisms such as first and second prisms 24′ and 24″ that are spaced apart from each other. The set of prisms can act as an interference generator and may direct towards one or more sensors (such as sensors 22 and 22′) portions of the radiation (transmitter and additionally reflected) taken at different location or different angles and thus provide additional information about the vibrations.

The set of prisms may include prisms that may differ from each other by their properties (such as transmission to reflection ratio).

FIG. 10 also illustrates a set of sensors such as first and second sensors 22 and 22′, wherein each sensor may be arranged to detect interference patterns generated by a single prism of the set of prisms.

It is noted that any of the mentioned above optical microphones 20 can be equipped with multiple sensors. A sensor may differ from another sensor by frequency response, by spatial coverage area and the like. For example, different sensors can be positioned to detect radiation reflected from different areas of the external auditory canal 11. When there are different sensors the sensors can be spaced apart from each other, close to each other or a combination thereof.

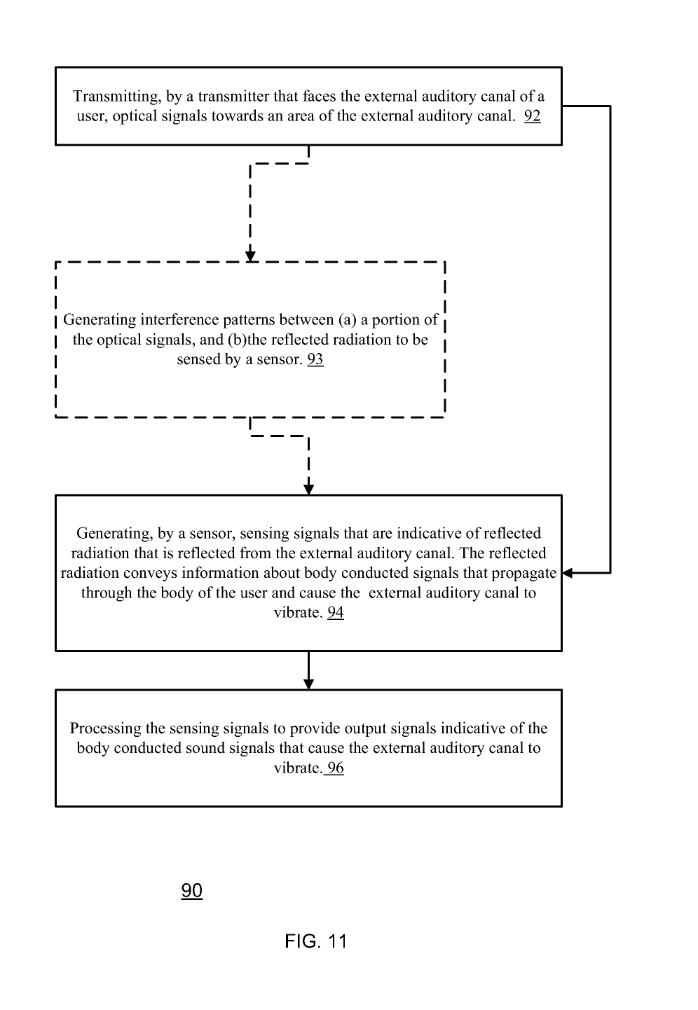

FIG. 11 illustrates a method 90 according to an embodiment of the invention.

Method 90 may start by stage 92 of transmitting, by a transmitter that faces at least one of an eardrum and an external auditory canal of a user, optical signals towards an area of at least one of the external auditory canal and the eardrum.

Stage 92 may include at least one of the following:
1. Transmitting at a certain point in time optical signals that form a beam of radiation.
2. Transmitting infrared optical signals.
3. Transmitting visible light optical signals.
4. Transmitting multiple beams of radiation.
5. Transmitting multiple beams of radiation that include at least two beams of radiation that differ from each other by frequency.
6. Transmitting multiple beams of radiation that include a visible light beam of radiation and an infra red beam.
7. Transmitting multiple beams of radiation that include at least two beams of radiation that are propagate along optical paths that are oriented in relation to each other.
8. Transmitting multiple beams of radiation that include at least two beams of radiation that differ from each other by frequency and direction of propagation.
9. Directing optical signals towards the illuminated area during time windows that are spaced apart in time.
10. Directing optical signals towards the illuminated area during time windows that are spaced apart in time, wherein a width of each time window is a fraction of a period between adjacent time windows.

Stage 92 may be followed by stage 94 of generating, by a sensor, sensing signals that are indicative of at least reflected radiation that is reflected from the external auditory canal. The reflected radiation conveys information about body conducted signals that propagate through the body of the user and cause external auditory canal to vibrate.

Stage 94 may include generating sensing signals that are indicative of reflected radiation that is reflected from the illuminated area of the external auditory canal.

Stage 94 may include generating sensing signals that are indicative of reflected radiation that is reflected multiple times from multiple illuminated areas of the external auditory canal.

Stage 94 may include generating the sensing signals by multiple sensors.

The multiple sensors may include at least two sensors that sense different wavelengths.

The multiple sensors may include at least two sensors that are arranged to sense radiation from different areas of an ear of the user.

Stage 94 may be followed by stage 96 of processing the sensing signals to provide output signals indicative of the body conducted sound signals that propagate through the body of the user and cause the external auditory canal to vibrate.

According to an embodiment of the invention stage 94 may be followed by stage 93 that in turn may be followed by stage 93—as illustrated by dashed box 93 and dashed arrows between this box and boxes 92 and 94.

Stage 93 may include generating interference patterns between (a) a portion of the optical signals, and (b) the reflected radiation; wherein the generating of the sensing signals is responsive to the radiation patterns.

The interference generator may be a prism.

Alternatively, the interference generator may be a set of prisms that comprises at least two spaced apart prisms. In this case stage 94 may include generating the sensing signals by a set of sensors; each sensor detects interference patterns generated by a single prism of the set of prisms.

Stage 94 may include at least one of the following:
1. Performing an amplitude based analysis of the detection signals to extract information about the body conducted sound signals.
2. Performing a phase based analysis of the detection signals to extract information about the body conducted sound signals.
3. Performing a polarization based analysis of the detection signals to extract information about the body conducted sound signals.
4. Suppressing information attributed to physical movements of the user.

It is noted that any of the mentioned above optical sensors can include a housing that can be adapted to block the external auditory canal (as illustrated in FIG. 1), although the housing can be arranged not to block the external auditory canal. In the latter arrangement the housing allows ambient signals to easily reach the eardrum.

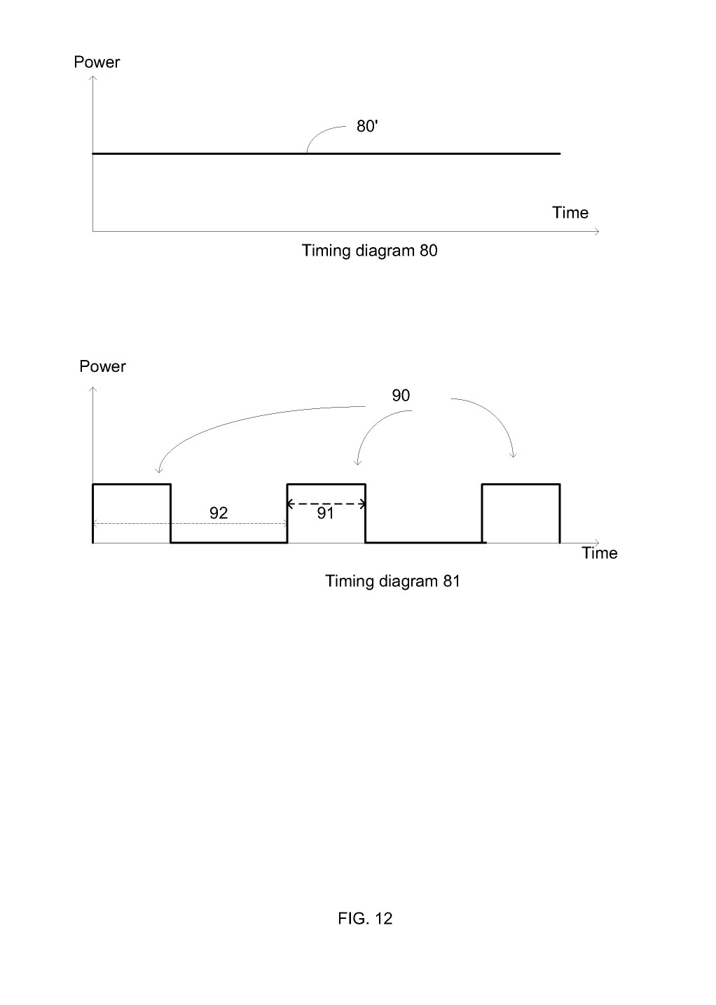

FIG. 12 comprises various timing diagrams that illustrate various manner of operation of an optical microphone according to various embodiments of the invention.

Timing diagram 80 include curve 80′ that illustrates a continuous mode of operation—the optical microphone 20 continuously illuminates the illuminated area with optical signals.

In the following timing diagrams the y-axis denoted a power of transmission and the x-axis denoted time.

Timing diagram 81 illustrates a non-continuous mode of operation—the optical microphone 20 illuminates the illuminated area during time shifted windows 90.

The relationship between the duration 91 of each time window 90 and the cycle 92 of the non-continuous mode of operation (the distance between the start point of consecutive time windows 90) determines the duty cycle of illumination and its frequency (being 1/cycle).

It is expected that the duty cycle can range between about 1-99 percent.

The frequency of the time windows may comply with the Nyquist criterion and may exceed twice the highest frequency of the body conducted sounds—thus it may exceed 4 Kilo-Hertz or may exceed 40 Kilo-Hertz.

During each time window the optical microphone can transmit one or more beams of radiation, the one or more beams of light can be transmitted concurrently, in a partially overlapping manner or in a non-overlapping manner.

During different time windows the optical microphone can transmit the same optical signals or different optical signals.

The following reference numbers are associated with the following elements:
10 Ear
11 External auditory canal
12 Eardrum
13 Illuminated area
20 Optical microscope
20(1) First part of optical microphone
20(2) Second part of optical microphone
21 Transmitter
22 Sensor
23 Processor
24 Interface generator
24′ Prism (first prism)
24″ Second prism
25 Light Emitting Diode (LED)
26 User motion rejection module.
27 Amplitude analyzer
28 Phase analyzer
29 Polarization analyzer
41 First optical signals
42 Transmitted optical signals
43 Second optical signals
44 Reflected radiation
45 Portion of reflected radiation
46 Interference pattern
70 Optics
71 Illumination optics
72 Collection optics

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between various entities are merely illustrative and that alternative embodiments may merge entities or impose an alternate decomposition of functionality upon various entities. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An optical microphone, comprising:
a transmitter; and
a sensor;
wherein the transmitter is arranged, when facing an external auditory canal of a user, to direct optical signals towards an area of the external auditory canal;
wherein the sensor is arranged to generate sensing signals that are indicative of reflected radiation that reflected from the external auditory canal; wherein the reflected radiation conveys information about body conducted signals that propagate through a body of the user and cause the external auditory canal to vibrate.

2. The optical microphone according to claim 1, wherein the sensor is coupled to a processor that is arranged to process the sensing signals to provide output signals indicative of the body conducted sound signals.

3. The optical microphone according to claim 1, further comprises a processor that is arranged to process the sensing signals to provide output signals indicative of body conducted sound signals that cause the external auditory canal to vibrate.

4. The optical microphone according to claim 2, wherein the processor comprises an amplitude analyzer that is arranged to perform an amplitude based analysis of the detection signals to extract information about the body conducted sound signals.

5. The optical microphone according to claim 1, wherein at a certain point in time the optical signals form a beam of radiation.

6. The optical microphone according to claim 1, wherein the optical signals form multiple beams of radiation.

7. The optical microphone according to claim 6, wherein the multiple beams of radiation comprise at least two beams of radiation that differ from each other by frequency.

8. The optical microphone according to claim 7, wherein the multiple beams of radiation comprise a visible light beam of radiation and an infra red beam.

9. The optical microphone according to claim 1, wherein the sensor is arranged to generate sensing signals that are indicative of reflected radiation that is reflected from the area of the external auditory canal.

10. The optical microphone according to claim 1, wherein the sensor is arranged to generate sensing signals that are indicative of reflected radiation that is reflected multiple times from multiple areas of the external auditory canal.

11. The optical microphone according to claim 1, wherein the processor comprises a user motion reduction module that is arranged to suppress information attributed to physical movements of the user.

12. The optical microphone according to claim 1, wherein the transmitter is arranged to direct optical signals towards the area during time windows that are spaced apart in time.

13. The optical microphone according to claim 1, comprising a housing that at least partially surrounds the transmitter, the sensor and the processor.

14. The optical microphone according to claim 1, comprising multiple sensors.

15. The optical microphone according to claim 14, wherein the multiple sensors comprise at least two sensors that are arranged to sense radiation from different areas of an ear of the user.

16. A method for detecting body conducted signals, the method comprises:
transmitting, by a transmitter that faces the external auditory canal of a user, optical signals towards an area of the external auditory canal;
generating, by a sensor, sensing signals that are indicative of reflected radiation that is reflected from the external auditory canal; wherein the reflected radiation conveys information about body conducted signals that propagate through a body of the user and cause the external auditory canal to vibrate.

17. The method according to claim 16, comprising processing the sensing signals to provide output signals indicative of the body conducted sound signals cause the external auditory canal to vibrate.

18. The method according to claim 16 comprising performing an amplitude based analysis of the detection signals to extract information about the body conducted sound signals.

19. The method according to claim 16, wherein the transmitting comprises transmitting at a certain point in time optical signals that form a beam of radiation.

20. The method according to claim 16, wherein the transmitting comprises transmitting multiple beams of radiation.

21. The method according to claim 16, comprising transmitting multiple beams of radiation that comprise at least two beams of radiation that differ from each other by frequency.

22. The method according to claim 16, comprising transmitting multiple beams of radiation that comprise a visible light beam of radiation and an infra red beam.

23. The method according to claim 16, comprising generating sensing signals that are indicative of reflected radiation that is reflected multiple times from multiple areas of the external auditory canal.

24. The method according to claim 16, comprises suppressing information attributed to physical movements of the user.

25. The method according to claim 16, comprising directing optical signals towards the area during time windows that are spaced apart in time.

26. The method according to claim 16, comprising generating the sensing signals by multiple sensors.

27. The method according to claim 26, wherein the multiple sensors comprise at least two sensors that are arranged to sense radiation from different areas of an ear of the user.
